(19) United States
(12) Patent Application Publication
(10) Pub. No.: US 2013/0108896 A1
(43) Pub. Date: May 2, 2013

(54) METHODS AND APPARATUS FOR COMBINED THERMAL MANAGEMENT, TEMPERATURE SENSING, AND PASSIVE BALANCING FOR BATTERY SYSTEMS IN ELECTRIC VEHICLES

(71) Applicants: Paul A. Daniel, Ashland, OR (US); Brian J. Wismann, Talent, OR (US); Lawrence O. Hilligoss, Ashland, OR (US); George Alter, Ashland, OR (US)

(72) Inventors: Paul A. Daniel, Ashland, OR (US); Brian J. Wismann, Talent, OR (US); Lawrence O. Hilligoss, Ashland, OR (US); George Alter, Ashland, OR (US)

(73) Assignee: BRAMMO, INC., Ashland, OR (US)

(21) Appl. No.: 13/285,208

(22) Filed: Oct. 31, 2011

(51) Int. Cl. H01M 10/50

(52) U.S. Cl. 429/50; 429/62

(57) ABSTRACT

A battery module in accordance with one or more embodiments includes a plurality of electrically connected battery cells and one or more heating devices in contact with each battery cell. Each of the heating devices includes one or more resistive heating elements configured for use in measuring and regulating temperature of the battery cells and for passively balancing electrical charge among battery cells.

### BACKGROUND

The present application relates generally to battery systems and, more particularly, to methods and apparatus for combined thermal management, temperature sensing, and passive balancing for battery systems in electric vehicles.

Battery systems used in electric vehicles must be able to perform under a wide variety of conditions not normally encountered with typical indoor battery applications such as consumer electronics, laptop computers, etc. Electric vehicles should be successfully operable in both winter conditions with sub-freezing temperatures as well as in summer conditions with high temperatures. Batteries typically have temperature restrictions that must be dealt with to allow operation without damaging the batteries. For instance, battery chemistries often do not allow for charging at low temperatures; the batteries must be heated to within a specified temperature range before charging can commence.

Battery systems for electric vehicles typically comprise several modules, which then in turn contains multiple individual batteries known as battery cells. Electric vehicles can have hundreds of battery cells, which are electrically and mechanically connected to form a battery system.

A battery module is a collection of battery cells, typically housed in a case, with a common set of terminals. The battery cells in a module can be electrically connected in series (for a greater voltage), in parallel (for greater capacity), or more typically using a combination of both. Cells can be worked on individually or collectively as a group. A module can be organized as a collection of individual cells that form a single group, or a collection of cells that form multiple groups within the same module. The structure of a cell group can be either in series or parallel (or both) depending on the design of the battery module. A battery pack is a collection of battery modules, forming the battery system. An electric vehicle typically has one battery pack.

When a battery system is charged, the battery cells in the system are charged together. However, the battery cells will charge at different rates because of variations among cells. This can result in some cells exceeding their maximum rated voltage, while other cells are insufficiently charged.

In order to keep a battery system operating at generally peak efficiency, charges among cells are equalized through a balancing process. The balancing process is performed by the battery module, and depending on the organization of the cells within the module, can balance on a cell by cell basis, group by group basis, or the entire module itself. An individual cell group that is charged significantly less than the other cell groups in a system can lower performance of the entire system. Balancing cell groups is typically accomplished by targeting a partial discharge on the higher voltage cell groups to bring it in line with the other cell groups, then continuing the charging process so that all the cell groups are more equalized. Cell group discharging is often accomplished by using large and costly power resistors.

### BRIEF SUMMARY

A battery module in accordance with one or more embodiments includes a plurality of electrically connected battery cells and one or more heating devices in contact with each battery cell. Each of the heating devices includes one or more resistive heating elements configured for use in measuring and regulating temperature of the battery cells and for passively balancing electrical charge among battery cells.

In accordance with one or more embodiments, a method is provided for thermally managing and passively balancing a battery module comprising a plurality of battery cells. The method includes the steps of measuring and regulating the temperature of the battery cells using resistive heating elements in contact with the battery cells; and passively balancing electrical charge among battery cells using the same resistive heating elements.

### BRIEF DESCRIPTION OF THE DRAWINGS

FIG. 1 is an exploded view of an exemplary battery module in accordance with one or more embodiments.

FIG. 2 is a simplified exploded view of a portion of the battery module.

FIG. 3 is a simplified perspective view of a portion of the battery module, illustrating the connection of battery cells to a heater pad.

FIG. 4 is a schematic diagram illustrating an exemplary measurement circuit in accordance with one or more embodiments.

FIG. 5 is a graph illustrating the linearity of the temperature coefficient of brass.

FIG. 6 is a graph illustrating an exemplary relationship between temperature and heating element resistance.

FIG. 7 is a schematic diagram illustrating an exemplary measurement circuit with multiple heating elements in accordance with one or more embodiments.

Like reference characters denote like parts in the drawings.

### DETAILED DESCRIPTION

As described in further detail below, battery systems in accordance with various embodiments provide combined thermal management, temperature sensing, and passive balancing. Such battery systems are particularly suited for use in electric vehicles, which must be operable under a variety of temperature conditions.

Thermal conditions for cells within a battery module should be monitored to ensure the cells are operating within a specified temperature range. This is ordinarily done using multiple temperature sensors spaced evenly throughout the module at which the temperatures can be read and analyzed. The use of multiple separate temperature sensors, each of which is wired individually, increases the complexity of the system, which in turn decreases its reliability. In addition, manual positioning of the sensors along with routing the sensor wires, adding connectors, and mounting the sensors increase the cost of the system.

In accordance with various embodiments, the battery system heater pads (which are positioned adjacent to the battery cells for heating the cells in cold temperature conditions) are also used as temperature sensors. This is possible because the resistance of the heater pad changes over temperature in a predictable manner, and this resistance change can be measured and monitored.

By avoiding the need for separate temperature sensors and sensor cables to be included in battery modules, the cost and complexity of the system is reduced. Reliability is also increased since there are no separate sensors, which can be subject to failure.

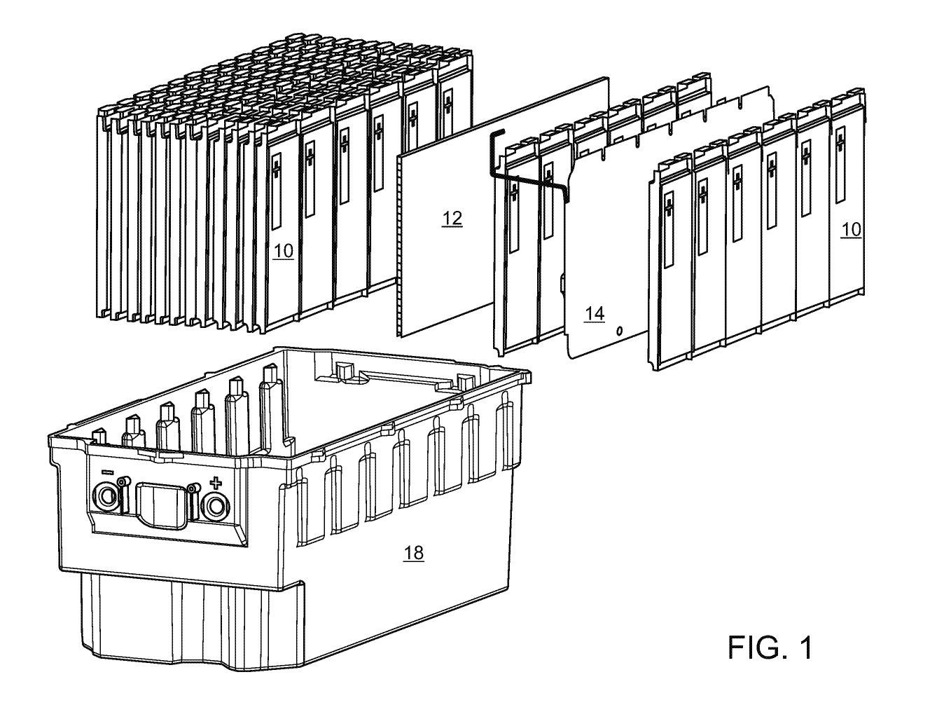

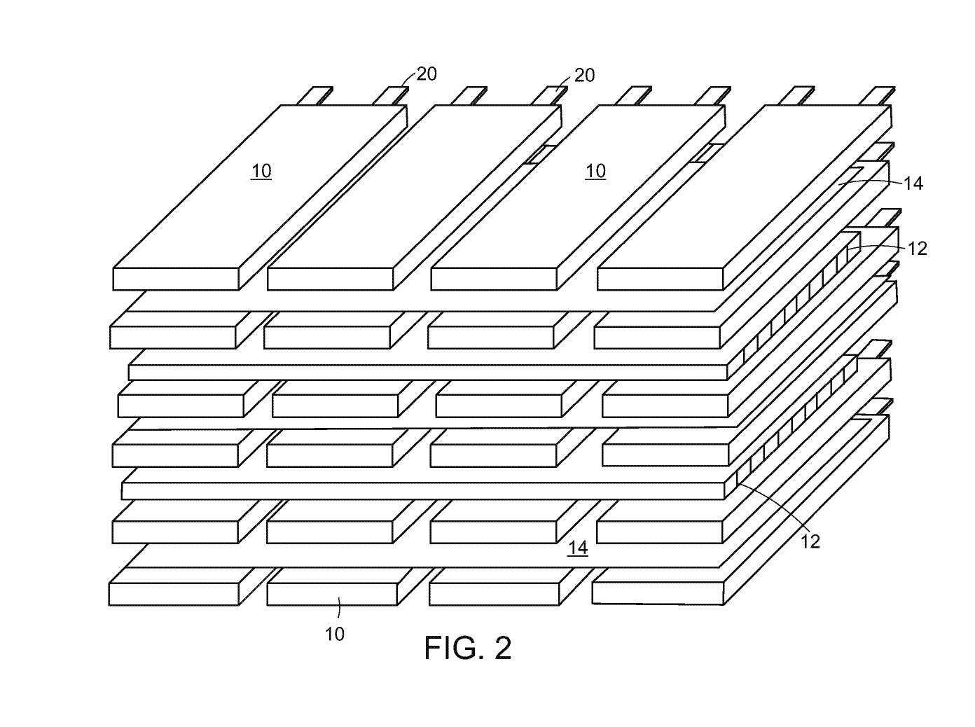

FIGS. 1 and 2 are exploded views of an exemplary battery module in accordance with one or more embodiments. The battery module includes a plurality of battery cells 10. The battery cells 10 are installed in rows and then stacked or arranged in layers, one on top of another or side-by-side. Located between the layers is either an air gap 12 (defined by a corrugated structure) or a heater pad 14. The air gaps 12 and heater pads 14 alternate within the battery structure such that each of the battery cells 10 (except for the outer cell rows) have an air gap 12 on one side thereof and a heater pad 14 on the opposite side thereof. The battery module components are housed in a case 18.

Each battery cell 10 includes terminals 20 that can be connected in series (for a greater voltage), in parallel (for greater capacity), or a combination of both.

The heater pads 14 include resistive heating elements in contact with the battery cells 10. As will be discussed in further detail below, the heater pads 14 measure and regulate the temperature of the battery cells 10 based on known resistive thermal characteristics of the material used in the heating elements and passively balance electrical charge among battery cells 10. This removes the need for expensive power resistors typically used for passive balancing, and the need for separate temperature sensors, thus simplifying the module construction by reducing the parts count of the system.

The air channels 12 between battery cell rows allow heat to be distributed among battery cells 10 to improve regulation of battery cell temperature. Heat distribution can be further improved by use of a small electric air fan within the module to direct the flow of air through the air channels thereby increasing the circulation of air within the module.

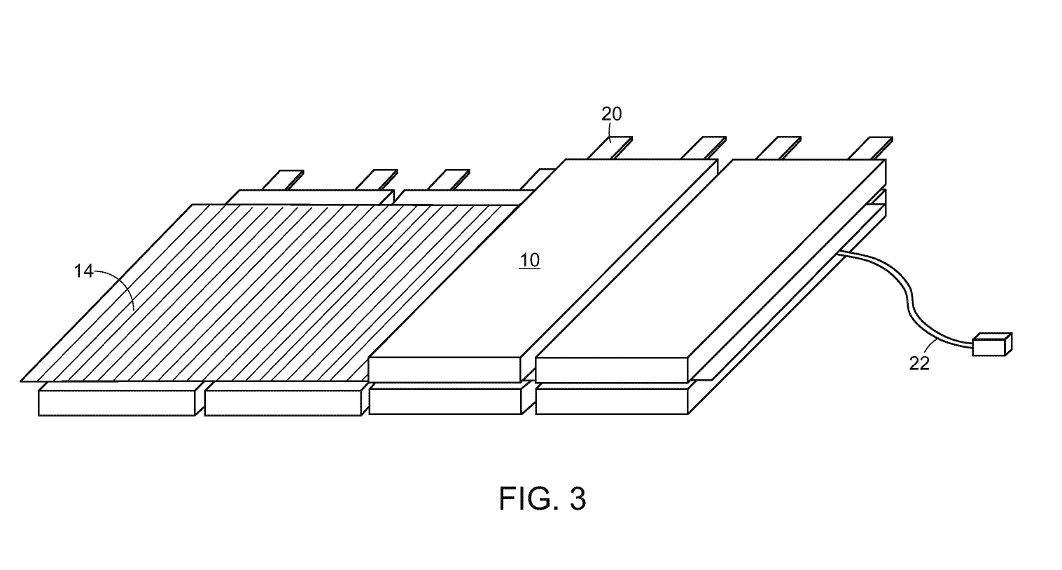

FIG. 3 is a perspective view of a heater pad 14 positioned between two rows of battery cells 10. For purposes of illustration, some of the battery cells 10 in the front cell row are shown removed. In the exemplary embodiment, the heater pads 14 each comprise a substrate having a resistive heating element film printed or otherwise deposited thereon. The heating elements can exist in many shapes and forms and function as an electrical resistor used for both low temperature charging as well as for charge balancing. A variety of metals, conductors and semi-conductors can be used for the heating elements, including e.g., brass. The substrate can comprise, e.g., plastic, polymer or other similar substances.

By being in direct contact with battery cells 10, the heating elements can provide quick, generally evenly distributed heating to the battery cells 10. Also rows of cells 10 and individual cells 10 can be heated separately as needed, allowing more flexible and controlled zone heating than heating by a central unit.

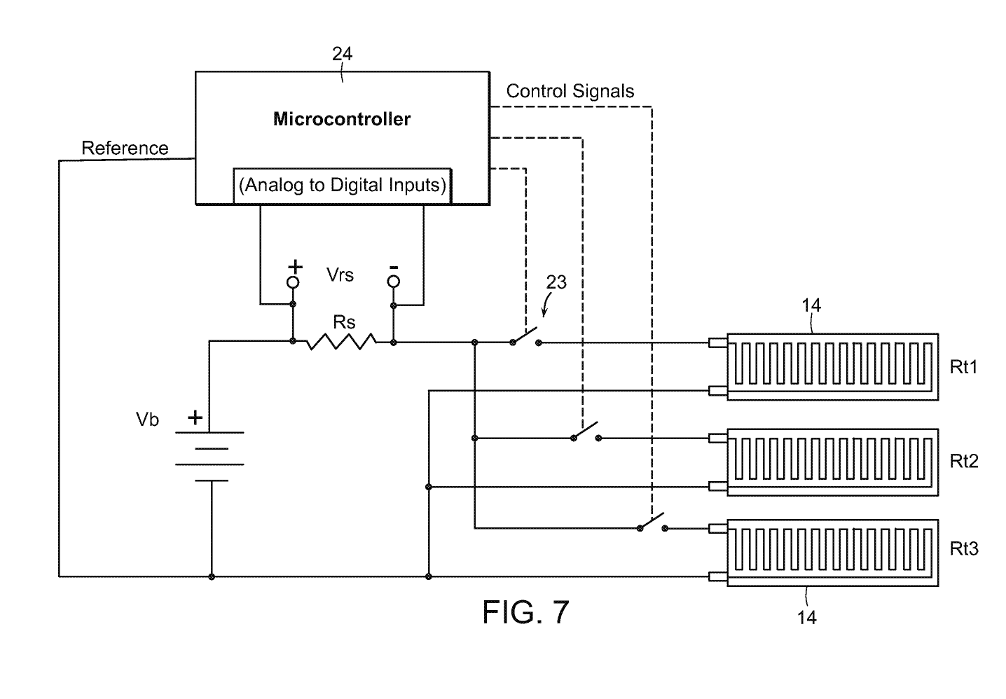

A connecting wire cable 22 connected to the terminals of the heater pad 14 is connected to an electrical switching device 23 (e.g., FET, Relay, etc.) that is set by a controller 24 (shown in FIG. 7).

The controller 24 controls operation of the resistive heating elements in the heater pads 14 to measure and regulate battery cell temperatures and to balance electrical charge among battery cells 10. In a preferred embodiment, the controller 24 can selectively and individually operate each of the resistive heating elements for intelligent heating. The resulting thermally controlled zones help minimize differences between cell capacities, and thus help keep all cells 10 operating in generally the same capacity as the adjacent cells 10. A variety of controllers can be used to perform these functions, including, e.g., an 8051-type microcontroller.

Selective temperature control is particularly advantageous when there is a very rapid thermal change (e.g., when the battery module is moved from a warm indoor room to a cold outside environment) where interior temperatures near the sides of the module may be significantly different than the center of the module due to the large thermal mass of the module. Under these conditions, applying the same heat to all the zones within the module would cause some cells 10 to become overly heated, while others remain cold. A selective heating system addresses this condition, and at the same time saves power as only the colder zones requiring heating will have their heating elements turned on.

Specific heating control within the battery module in accordance with one or more embodiments allows individual battery cells 10 to be better thermally managed. Specific control of heating elements also makes it easier to control the charging and discharging of battery cells 10, thereby reducing differences between battery cells 10 in capacity, impedance, and charge/discharge rates.

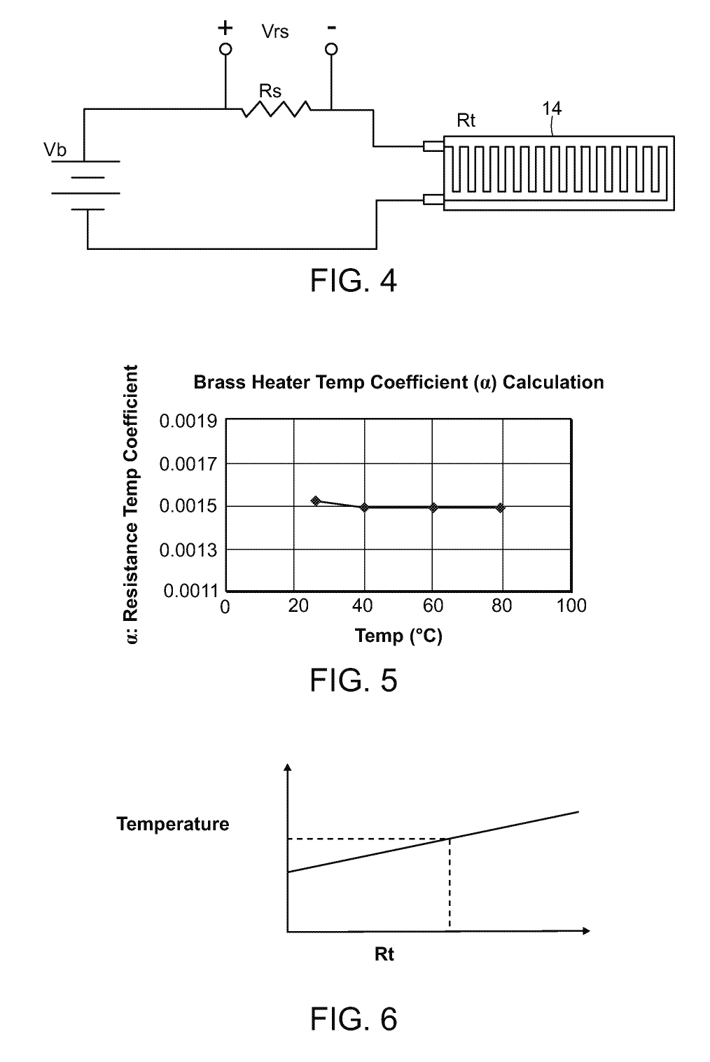

FIG. 4 is a schematic diagram illustrating an exemplary measurement circuit including a heater panel 14, a series resistor (Rs), and a source of energy (Vb) in accordance with one or more embodiments. Vb is a DC source and can be either internal (e.g., battery cells 10, or the module itself) or external (e.g., a charger).

The actual values of Vb and Rs are known entities. Rt, which is the resistance of the heater panel 14, will vary according to thermal response. The current in the loop can be calculated by measuring the voltage drop across Rs (as shown by the test points):

I=Vrs/Rs

Now that the current in the loop is known, Rt can be calculated as:

Rt=(Vb−Vrs)/I

There is a direct relationship between the temperature of the heater pad and the corresponding heater pad resistance. This relationship is based on the temperature coefficient of the material used in the heating element. A variety of metals, conductors and semi-conductors can be used in the heating element. Brass is one example of a conductor that can be used in the heating element. FIG. 5 illustrates the linearity of the temperature coefficient for brass as a conductor.

Knowing the value of the heater panel's resistance, the temperature can be calculated by a graph (e.g., FIG. 6), calculation, or a Look-up Table (LUT).

Temperature calculation can be performed by using a single known reference point, along with the temperature coefficient of the heater's conducting (or semi-conducting) material.

T=(π/π₀−1+αT₀)/α

Where

ρ resistance in ohms at temp T deg C

ρ₀ known resistance in ohms at temp T₀ deg C

Vₘ voltage measured or calculated as Vb-Vs) across brass heater

Iₘ current measured into the brass heater (same as the loop current)

α metal resistance temp coefficient (see, e.g., FIG. 6 graph)

T temp at deg C.

T₀ temp at known resistance ρ₀

The values can also be pre-calculated using a Look-up Table (LUT), using the calculated resistance as the value to index the LUT.

FIG. 7 illustrates an exemplary measurement circuit for a battery module with multiple battery cells 10. Multiple heating panels 14 are provided, each for one of the battery cells 10. The measurement circuit is extended to include additional sensing by adding the appropriate number of heater pads 14, each controlled internally by a sequencer, processor or other means of electrical selection 24 that in turn runs a switch, transistor (e.g., FET), or relay to individually select an individual heater panel 14.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments. Additionally, elements and components described herein may be further divided into additional components or joined together to form fewer components for performing the same functions. Accordingly, the foregoing description and attached drawings are by way of example only, and are not intended to be limiting.

What is claimed is:

1. A battery module, comprising:
a plurality of electrically connected battery cells; and
one or more heating devices in contact with each battery cell, each of said one or more heating devices including one or more resistive heating elements configured for use in measuring and regulating temperature of the battery cells and for passively balancing electrical charge among battery cells.

2. The battery module of claim 1, wherein the battery module is configured for use in an electric vehicle.

3. The battery module of claim 1, wherein the battery cells are electrically connected in series, in parallel, or both.

4. The battery module of claim 1, wherein the one or more heating devices are positioned between battery cells.

5. The battery module of claim 1, wherein each cell in the battery module is in contact with an air channel, and wherein heat from the one or more heating devices is transferred through the battery cells and air channels to regulate the temperature of other battery cells.

6. The battery module of claim 1, wherein the battery cells can be selectively heated by the one or more heating devices to provide multiple heating zones within the battery module.

7. The battery module of claim 1, wherein each of the one or more resistive heating elements comprises an electrically resistive heating material with a known predictable temperature coefficient.

8. The battery module of claim 1, wherein each of the one or more resistive heating elements comprises one or more electrical resistors printed, etched, or laminated on a substrate.

9. The battery module of claim 1, further comprising a generally sealed outer enclosure for housing the battery cells and the one or more heating devices.

10. The battery module of claim 1, wherein a battery cell temperature is determined based on the measured resistance of the one or more resistive heating elements.

11. The battery module of claim 1, further comprising a controller for controlling operation of the resistive heating elements to measure and regulate battery cell temperatures and to balance electrical charge among battery cells.

12. The battery module of claim 1, wherein each heating device includes multiple resistive heating elements, and wherein the battery module further comprises a controller for selectively operating each of the multiple resistive heating elements to measure and regulate battery cell temperature and to balance electrical charge among battery cells.

13. The battery module of claim 12, wherein the controller operates a switch, transistor, or relay to individually select a resistive heating element to thermally manage the cells or to passively balance the cells.

14. A method of thermally managing and passively balancing a battery module comprising a plurality of electrically connected battery cells, the method comprising:
measuring and regulating temperature of the battery cells using one or more resistive heating elements in contact with the battery cells; and
passively balancing electrical charge among battery cells using said one or more resistive heating elements.

15. The method of claim 14, further comprising providing air channels between battery cells such that heat is transferred through battery cells and air channels to regulate the temperature of the battery cells.

16. The method of claim 14, wherein regulating temperature of battery cells comprises selectively heating the battery cells.

17. The method of claim 14, wherein measuring the temperature of a battery cell comprises determining the temperature based on a measured resistance of the one or more resistive heating elements.

18. The method of claim 14, further comprising using a controller for controlling operation of the resistive heating elements to measure and regulate battery cell temperatures and to passively balance electrical charge among battery cells.

19. The method of claim 14, wherein the battery module is configured for use in an electric vehicle.

20. The method of claim 14, wherein passively balancing electrical charge among battery cells comprises passively balancing electrical charge among individual battery cells or one or more battery cell groups.
